(19) United States
(12) Patent Application Publication
(10) Pub. No.: US 2009/0109287 A1
(43) Pub. Date: Apr. 30, 2009

(54) INSPECTING METHOD AND INSPECTING SYSTEM OF ASSEMBLY

(76) Inventors: Ichiro SASAKI, Ichikawa (JP); Noriyuki Sadaoka, Tokai (JP); Masatoshi Watanabe, Ushiku (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/260,108

(22) Filed: Oct. 29, 2008

(30) Foreign Application Priority Data
Oct. 31, 2007 (JP) 2007-283817

(51) Int. Cl. H04N 7/18

(52) U.S. Cl. 348/92; 348/E07.085

(57) ABSTRACT

An inspecting system of an assembly, for inspecting the assembly, by obtaining three-dimensional position relationship, in short time, for each of parts building up the assembly, comprises: a data editor/processor portion 2 for storing design data therein, and for producing/editing a calculated projection view; a brightness calculating portion 3 for calculating brightness in vicinity of boundaries, which are obtained when photographing the part to be extracted in plural numbers of directions, from the design data, for each direction; a sensitivity determining portion 4 for determining sensitivity of the photographing apparatus upon basis of the brightness, so that the projection image becomes clear in the vicinity of said boundaries; a photographing apparatus 5 for obtaining the projection images in the plural number of directions for the assembly conveyed; a video processor portion 6 for conducting video processing with converting the projection image into an electric signal, as an actual projection view; and a determination portion 8 for determining success or failure of the assembly, depending upon the part presented on the actual projection lies or not within a tolerable region of the part, which is presented by the calculated projection view.

### BACKGROUND OF THE INVENTION

The present invention relates to an inspecting method of an assembly, which is constructed with a plural number of parts, and in particular, it relates to an inspecting method for conducting an inspection of the condition of assembling, with using a projection drawing calculated, which is obtained from design data, and a projection image of an interior condition of the assembly, which is obtained by photographing. Further, it relates to an inspecting system of applying this method therein.

In general, an industrial product is an assembly made up with a plural number of parts thereof. For inspection of such the product, it is necessary to inspect the condition of assembling (for example, the degree of parallelism, and/or concentricity, etc.), in addition to an inspection of sizes for each part.

Conventionally, for the purpose of inspecting the condition of interior assembling, an X-ray projection apparatus is well applied. Within the X-ray projection apparatus, X-rays are irradiated upon an assembly, so as to detect that penetrating therethrough by a camera, and thereby obtaining the projection image thereof. The X-rays are attenuated in intensity or strength thereof, when penetrating through a substance, depending upon an attenuation factor and a penetration length (i.e., a distance which the X-rays advance in the substance), both of which are specific for that material. Accordingly, it is possible to know the position for each part within an inside of the assembly with an aid of the projection image.

Also, it can be considered to apply an X-ray CT (Computed Tomography) apparatus, as other method for the above. This X-ray CT apparatus, while obtaining the projection images through irradiation of the X-rays in a large number of directions surrounding the assembly, obtains a reconstructed image (i.e., the cross-section view) from an aggregate of a large number of projection images. Actually, the projection images, on which one-dimensional Fourier transformation is conducted in each direction, are composed so as to produce a two-dimensional Fourier transformation image, and on this is conducted inverse Fourier transformation, thereby obtaining the reconstructed image.

For example, in the following Patent Document 1 is disclosed a method for inspecting defects on wiring patterns and defects in through holes, irradiating the X-rays on one surface of a print circuit board to be inspected, so as to detect the X-rays penetrating through to the opposite surface for imaging, and to compare the image obtained with size data of the wiring patterns and data of the through holes and the hole diameters thereof, which are given in advance.

Also, in the following Patent Document 2 is disclosed an inspecting method for conducting an inspection of a multi-layer substrate, by producing an image of three-dimensional structures of an inside of that substrate, with using a photographing result by using the X-ray CT apparatus in the direction perpendicular to a multi-layered substrate, and the designed values in the horizontal direction thereof.

[Patent Document 1] Japanese Patent Laying-Open No. Hei 07-235773 (1995); and

[Patent Document 2] Japanese Patent Laying-Open No. Sho 60-161551 (1985).

### BRIEF SUMMARY OF THE INVENTION

However, with the technology disclosed in the Patent Document 1, there is a problem, though it is possible to identify the position in the direction perpendicular to propagating direction of the X-rays irradiated, but it is impossible to identify the position in the propagating direction of the X-rays.

Also, with the technology described in the Patent Document 2, because of obtaining a large number (for example, 1,200 pieces) of projection images for one (1) piece of an assembly, it takes a time for photographing, and the calculation for reconstruction also needs a time, because it repeats the Fourier transformation; i.e., it needs one (1) hour, or more or less, in total for one (1) piece. Also, there are sometimes cases where a virtual image appears, which is called “artifact” specific to the X-ray CT apparatus, and this sometimes brings about an obstacle or difficulty. For this method, because the three-dimensional structures of the assembly are clear, it is possible to avoid the condition that the position cannot be identified in the propagating direction of the X-rays, as was mentioned above. However, it takes the time too long, and therefore it is impossible to apply this in the inspection for the products of mass-production.

According to the present invention, by taking the drawbacks mentioned above into the consideration thereof, an object thereof is to provide an inspecting method for inspecting the interior condition of and assembly, i.e., a target to be inspected, by obtaining the three-dimensional position relationships among the parts building up the assembly, in a short time. Further, another object thereof is to provide an inspecting system for the assembly with applying the inspecting method therein.

For accomplishing the object mentioned above, according to the present invention, there is provided an inspecting method of an assembly, for inspecting said assembly, being constructed with a plural number of parts, upon basis of a calculated projection view of showing an interior condition of parts of said assembly, which is obtained through calculation of design data of the assembly, and a projection image for showing the interior condition of parts of said assembly, which is obtained by a photographing apparatus after assembling said assembly, comprising the following steps of: a step for calculating brightness in vicinity of boundaries, which are obtained when photographing the part to be extracted in plural numbers of directions, from said design data, for each direction; a step for determining sensitivity of said photographing apparatus upon basis of said brightness, so that the projection image becomes clear in the vicinity of said boundaries; a step for obtaining the projection images in the plural number of directions for said assembly, by said photographing apparatus; a step for conducting video processing with converting said projection image into an electric signal, as an actual projection view; and a step for determining success or failure of said assembly, depending upon said part presented on said actual projection lies or not within a tolerable region of said part, which is presented by said calculated projection view.

In this manner, since the brightness in the vicinity of boundaries of the part to be extracted can be calculated in each direction for photographing, thereby to determine the sensitivity of the photographing apparatus, as well as, to conduct the photographing in plural numbers of directions, therefore it is possible to provide the inspecting method of an assembly, for conducting an inspection of an interior condition, in short time, within the assembly, i.e., a target to be inspected.

Also, it is possible to provide the inspecting apparatus, applying therein the inspecting method of the assembly mentioned above.

According to the present invention mentioned above, since the three-dimensional position relationship can be known, in shot time, for each of the parts building up the assembly, therefore it is possible to provide an inspecting method of an assembly for conducting an inspection of success or failure of the assembly, with high efficiency.

Further, it is also possible to provide an inspecting system of an assembly, by applying the inspecting method mentioned above therein.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a view for explaining the concept or idea of an inspecting method for an assembly, according to an embodiment of the present invention;

FIGS. 2A to 2C are views for showing the cress-section views in X-, Y- and Z-directions of the assembly mentioned above;

FIGS. 3A and 3B are views for explaining the concept or idea of a determining pass-fail test for the assembly;

FIG. 4 is a view for showing the brightness of a target and the position relationship thereof on a pickup image of the assembly mentioned above;

FIG. 5 is an outline structural view of an inspecting system for an assembly, according to an embodiment of the present invention;

FIG. 6 is a perspective view for showing an embodiment 1, according to the present invention;

FIG. 7 is a view for showing steps for the inspection of the assembly, according to the embodiment 1;

FIG. 8 is a view for showing an example of embodying the present invention by only one (1) set of an image pickup apparatus in the embodiment 1; and

FIG. 9 is a perspective view for showing an embodiment 1, according to the present invention.

### DETAILED DESCRIPTION OF THE PREFERRED EMBODIMENTS

Hereinafter, embodiments according to the present invention will be fully explained by referring to the attached drawings.

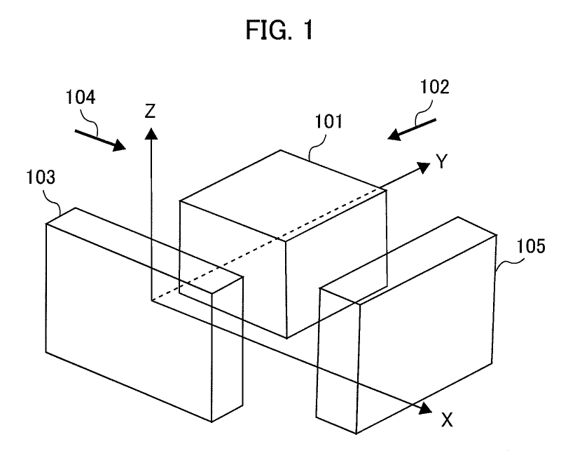

FIG. 1 attached herewith is a view for explaining a concept or an idea of an inspecting method for an assembly, according to an embodiment of the present invention. In the inspecting method mentioned above, for obtaining the three dimensional position relationships, in a shot time, not only an actual projection view in one (1) direction, but also actual projection views in plural numbers of directions are combined with the calculated projection drawing indicating an interior condition of parts in that assembly, which obtained by calculating design data. Herein, the actual projection view means a view or drawing obtained by digitizing an analog projection image, which is obtained by photographing by a camera under the condition of irradiating the X-rays upon the assembly, so as to easily conduct the video processing thereon. In FIG. 1, X-rays are irradiated in two (2) directions on the assembly, each being perpendicular to the X-rays, and two (2) pieces of the actual projection drawings are used, which are picked up in each of the directions. The coordinates are set for the assembly 101 (enough to be arbitrary), and the X-rays 102 and 104 are irradiated in X-direction and Y-direction, respectively, thereby obtaining the projection image thereof by the cameras 105 and 103, respectively.

However, the design data mentioned above includes, for example, three-dimensional coordinates for indicating the position of each part within the assembly, and sizes and angles, etc., for identifying the each part.

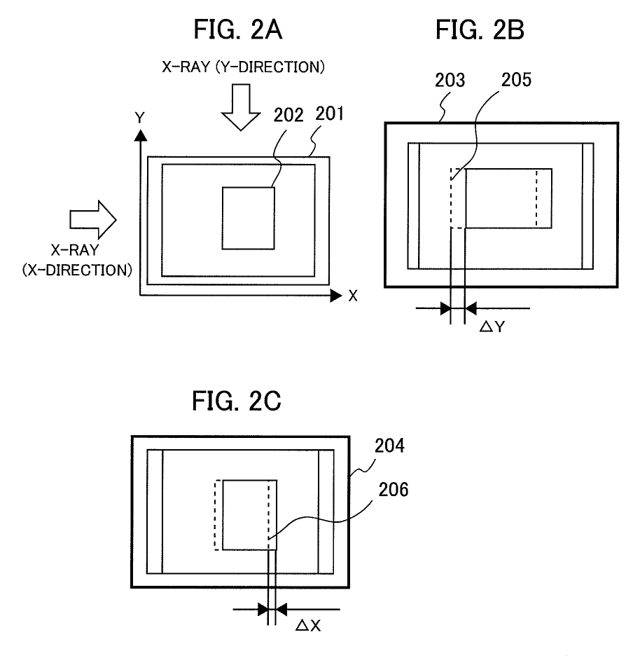

FIGS. 2A to 2C show the cross-section views in X-, Y- and Z-directions of the assembly, wherein FIG. 2A shows the cross-section view at an arbitrary direction of Z-axis, FIG. 2B the actual projection view in the direction of X-axis obtained by the camera 105 mentioned above, and FIG. 2C the actual projection view in the direction of Y-axis obtained by the camera 103 mentioned above, respectively. The assembly has such the structure that am interior part(s) is/are disposed in an inside of an exterior part 201. On the actual projection view 203 in the X-axis direction, the calculated projection view 205 of the interior part 202 is shown with broken lines, which is obtained through calculation from the design data. However, in this instance, for the purpose of indicating an actual difference of the interior part 202, the calculated projection view of the exterior part 201 must be piled on the actual projection view, which is actually obtained, completely. Also, in the similar manner, on the actual projection view 204 in the Y-axis direction is shown the calculated projection view 206 of the interior part 202, which is obtained through the calculation, by broken lines.

From the actual projection views 203 and 204 in both directions, it is possible to obtain the differences ΔX and ΔY between the calculated projection view and the actual projection view, and with this, the position relationship of the interior part 202 becomes clear with respect to the exterior part 201. Though the mentioned above is about the difference of the actual projection view from the design data obtained at the arbitrary position in the Z-axis direction, but by conducting this at all of the positions in the Z-axis direction, it is possible to obtain the three-dimensional position relationship of the interior part with respect to the exterior part, such as, an inclination of a center axis of the interior part 202, etc. With this, an inspection can be made on the condition of the assembly.

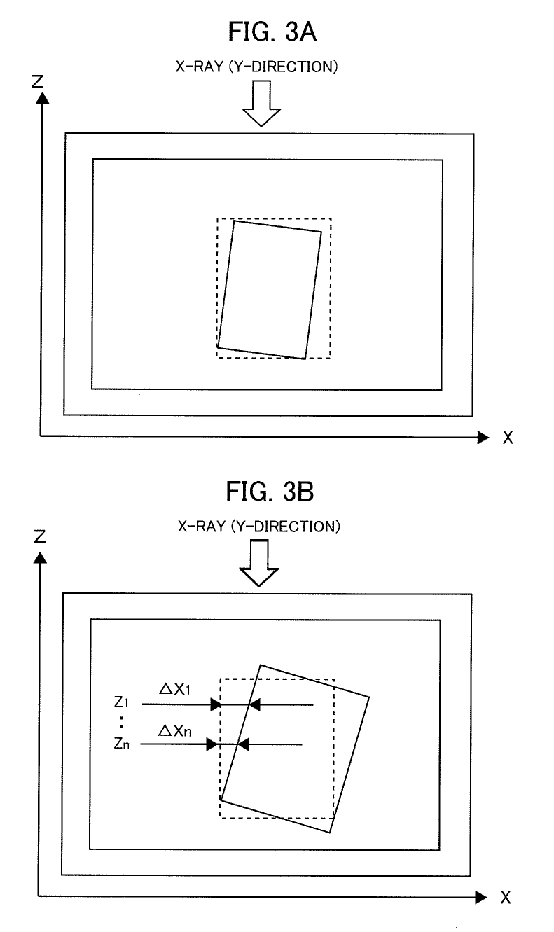

In more details, for determination on success or failure of the assembly, the following two (2) ways can be considered. One is a method, as is shown in FIG. 3A, while adding an allowable or tolerable region (for example, if the target of inspection is the coaxialism or concentricity of shafts between the parts, the region of the parts on the actual projection view, corresponding to the tolerance of shift for the shafts), which is indicated by the broken lines on the calculated projection view, thereby determining on success or failure, momentarily, by only piling up the actual projection view of solid lines on this, which is obtained through the X-ray photographing.

The other one is a method, as shown in FIG. 3B, of determining on success or failure, as was mentioned above, at an arbitrary Zn, while obtaining differences (ΔX₁, ΔX₂ . . . ΔXₙ) from the actual projection view of the solid line, which is obtained through the X-ray photographing, the position(s) of the part(s) to be inspected, and the calculated projection view of dotted lines upon the design data, including the position and the angle of the part to be inspected, this difference is compared with the tolerable value of the difference, which is determined in advance. In this case, not only the success or failure, but also the difference can be obtained in the form of a numerical value, and therefore it is possible to grasp a tendency of the difference (for example, it varies at random, or is in tendency of increasing, etc.).

For inspecting the condition of an interior of the assembly, it is necessary to know the condition of arrangement, correctively, of the respective parts building up the assembly, from the actual projection view obtained. However, depending upon the condition of arrangement of the parts within an inside of the assembly, there are sometimes cases where a boundary lines between the parts has width, so that it becomes dim or unclear.

Then, according to the present inspecting method, the brightness of the calculated projection view and the actual projection view are presented as an aggregation of dots of 16 bits (i.e., 0 to 65,535), and a region of brightness is calculated from the design data, in advance, in the vicinity of boundaries to be extracted in plural numbers of directions, thereby determining a sensitivity of the camera corresponding to the brightness calculated, so as to enable the photographing.

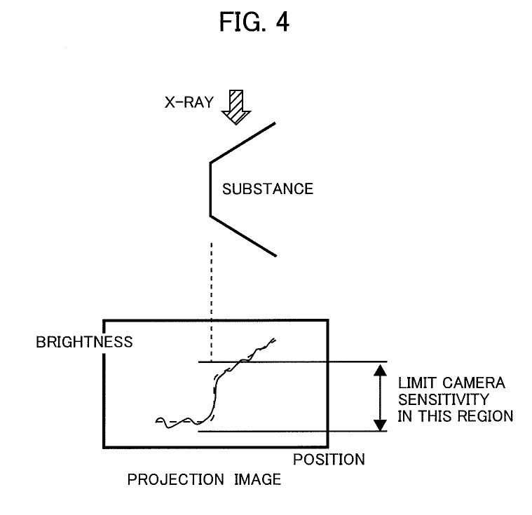

Explanation will be made in more details by referring to FIG. 4. This FIG. 4 shows the brightness in the vicinity of boundary of the part to be extracted and the position relationship thereof. A solid line shows the actual projection view in a certain direction, which is picked up through the X-rays, and a broken line shows the calculated projection view in that direction, which is obtained through calculation. The vertical axis indicates the brightness, and the horizontal axis the position of a substance, respectively. Calculating the region of brightness in that direction from the design data, depending on the position where the part is disposed, narrows or closes up that region, and thereby enabling to determine the sensitivity of the camera corresponding to that region. This sensitivity setup is able for each photographing of the part to be extracted. This differs from that a predetermined number of times of the photographing are required at the same sensitivity, such as, like in the X-ray CT apparatus. In this manner, since the sensitivity of the camera can be determined for each photographing, depending on the condition of disposing the part, it is possible to obtain the actual projection view in short time, and thereby to determine the success or failure of the assembly.

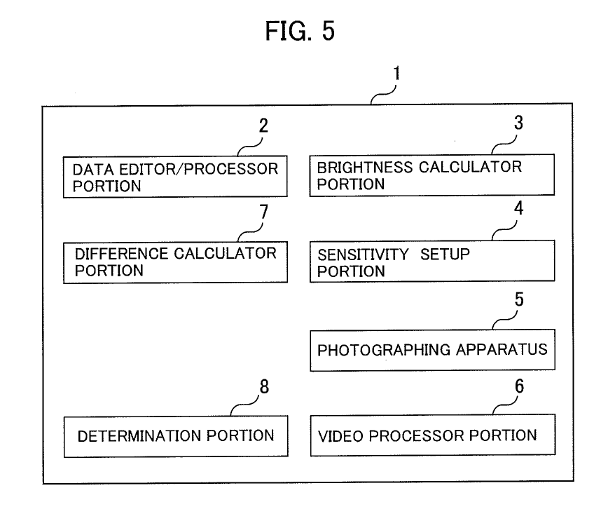

Next, explanation will be given on an inspecting system for an assembly for achieving such the inspection as was mentioned above. FIG. 5 is an outline structure view of an inspecting system for an assembly, according to an embodiment of the present invention. The inspecting system 1 comprises a data editor/processor portion 2 for storing the design data and producing/editing the calculated projection view, a brightness calculator portion 3 for calculating the brightness in the vicinity of boundary of the part to be extracted upon basis of the calculated projection view mentioned above, a sensitivity setup portion 4 for determining the sensitivity of the image pickup apparatus mentioned above, so that the projection view is clear, in particular, in the vicinity of that boundary upon basis of the calculated brightness mentioned above, the image pickup apparatus 5 for obtaining the projection images in plural numbers of directions, for the assembly conveyed, a video processor portion 6 for producing the actual projection view made of the digital data, by converting the projection image into electric signals, a difference calculator portion 7 for calculating the difference between the position of the part presented on the actual projection view obtained from the video processor portion 6 mentioned above, and the position of that part presented on the calculated projection view, and a determination portion 8 for determining the success or failure of that assembly.

The data editor/processor portion 2 stores the design data, such as, the coordinates for indicating the portion of apart within the assembly, and sizes and an angle of the part, etc., and further, it produces the calculated projection view with using this design data.

The brightness calculator portion 3, as was mentioned previously, because the brightness differs from depending on the condition of disposing the part, calculates out the brightness in the vicinity of boundary of the part to be extracted, upon basis of the calculated projection view. Upon basis of the brightness, which calculated within the brightness calculator portion 3, the sensitivity setup portion 4 converts it into a sensitivity corresponding to the camera of the image pickup apparatus 5. Herein, determination of the sensitivity can be made for each photographing, differing from the X-ray CT apparatus. The image pickup apparatus 5 may be an X-rays image pickup apparatus, which is made up with an X-rays generating apparatus and a camera.

The video processor portion 6 converts the actual projection view, which is picked up by the image pickup apparatus 5 mentioned above, into the electric signals, such as, digital data, which can be easily treated by video processing, and the actual projection view is produced by conducting the video processing thereon.

The determination portion 8 has a function of determining the success or failure of the assembly, depending on whether the position of the part of the assembly on the actual projection view lies or not within the tolerable region of the position of the part on the calculated projection view, which is obtained from the data editor/processor portion 2, and a function of determining the success or failure of the assembly, depending on whether the difference calculated within the difference calculator portion lies or not within the tolerable value of the difference, which is obtained from the data editor/processor portion 2.

### Embodiment 1

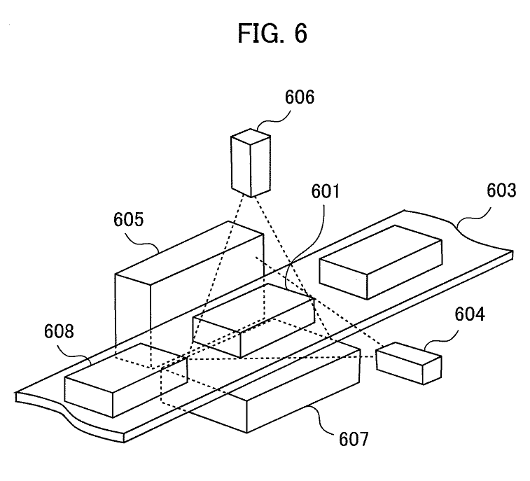

FIG. 6 is a view for showing the inspecting method for inspecting accuracy of assembling of the mass-produced assembly, according an embodiment 1. The assemblies 601 to be inspected are mounted on a conveyer table 603 at a predetermined distance therebetween. The X-ray emitting from an X-ray generator apparatus 604 passes through the assembly 601 in the horizontal direction, and reaches to a camera 605; thereby obtaining the projection image in the horizontal direction. Also, the X-ray emitting from an X-ray generator apparatus 606 passes through the assembly 601 in the vertical direction, and reaches to a camera 607; thereby obtaining the projection image in the vertical direction. However, in case where the conveyer table 603 prevents the X-ray projection image from being obtained, the material of the table may be changed or a hole may be provided. The projection image obtained in this manner is converted into an electric signal within the video processor portion 6, and it is transmitted to the determination portion as the actual projection view. In the determination portion 8, determination is made on whether the position of the part on the actual projection view lies within the tolerable region or not of the position of the part on the calculated projection view, with using the calculated projection view produced within the data editor/processor portion 2.

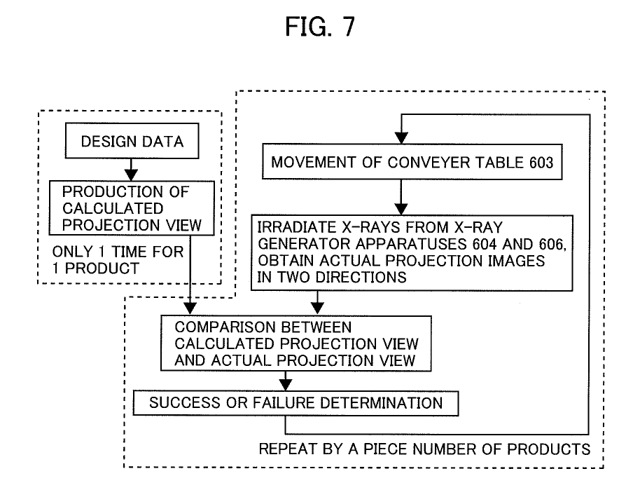

FIG. 7 attached herewith shows the steps of the inspection, according to the present embodiment 1. The assembly 601 is mounted on the conveyer table 603 to move thereon. When the assembly 601 passes through the photographing position, two (2) sets of the X-ray generator apparatuses 604 and 606 are operated at the same time, so as to obtain the projection views in the horizontal direction and the vertical direction, respectively, by the cameras 605 and 607. Also, it is possible to stop the assembly 601 at the photographing position, one time, so as to make the photographing by taking time (for the purpose of noise reduction). In this instance, as was mentioned above, it is also possible to determine the sensitivities of the cameras 605 and 607, again, for fitting to the brightness in the vicinity of boundary of the part to be extracted. After completing the photographing, the conveyer table 603 moves so that the next assembly 608 reaches to the photographing position. On the other hand, the projection images in the horizontal direction and the vertical direction are transmitted to the video processor portion 6 mentioned above, and they are converted into the electric signals, to be transmitted into the determination portion 8, as the actual projection view. Herein, it is compared with the calculated projection view, which is produced within the data editor/processor portion 2.

In this manner, the three-dimensional position relationship can be obtained among the parts building up the assembly, in short time, and therefore it is possible to inspect of the interior condition of the assembly, i.e., an object to be inspected.

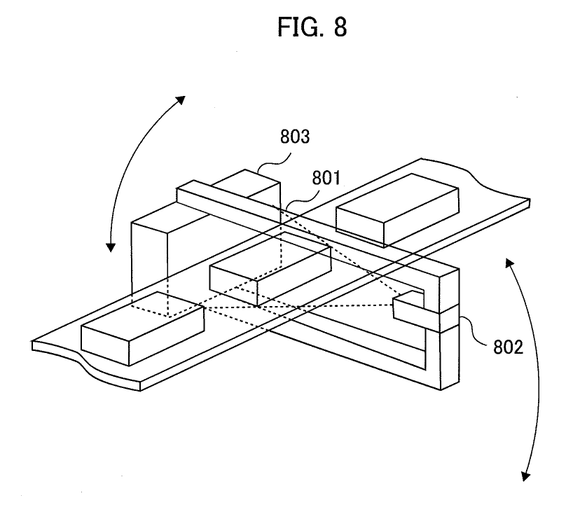

The mentioned above is the explanation of the case of using two (2) sets of the photographing apparatuses, each being made up with the X-ray generator apparatus and the camera, however in FIG. 8 is shown a case of using one (1) set of the photographing apparatus therein. The conveyer table and the assembly are same to those shown in FIG. 6, but an X-ray generator apparatus 802 and a camera 803 are combined in one body, to be rotatable in the direction of arrows. In this case, it is impossible to make the photographing in the plural number of directions, at the same time, as shown in FIG. 6, then the throughput is lowered, but it is possible to obtain the actual projection view in the most appropriate direction (i.e., with high accuracy) for a sort of the part, and also to obtain the projections view in an arbitrary number of directions, not restricted only two (2) directions, with the actual projection views obtain able. Accordingly, the conventional X-ray CT apparatus can be used, depending on necessity thereof.

### Embodiment 2

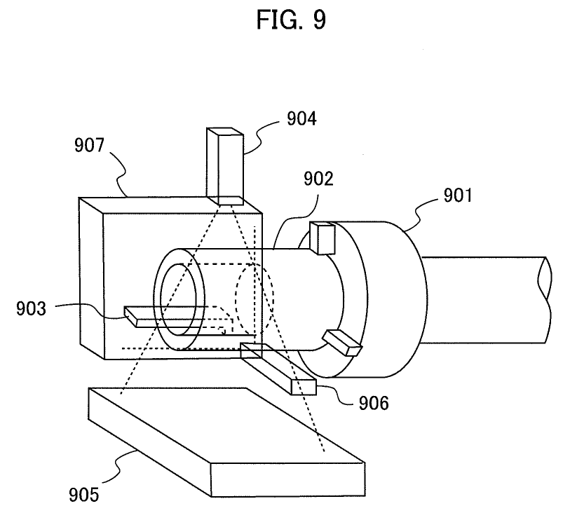

FIG. 9 attached is a view for showing an embodiment 2 of the present invention, and is a view for showing the condition of photographing with X-ray while cutting an inside a hole of cylinder-type with using a lathe. On a rotation shaft 901 of the lathe is attached a part 902, and the inside of the part 902 is cut by means of a bite (cutting tool) 903. At the positions where the hole and the bite 903 under machining can be photographed with X-ray are provided a set of the X-ray generator apparatus 904 and the camera 905 and a set of the X-ray generator apparatus 906 and the camera 907, respectively.

While adding the cutting depth of the part 902 at a predetermined rotation speed of the rotation shaft 901 and the position of the bite 903 as the design data, upon this design data is obtained the calculated projection view, in advance, and this is compared with the actual projection view, which is obtained through the photographing, thereby it is possible to obtain a difference between the calculated position of a tip of the bite 903 and the actual position thereof. Correction of the position of holding the bite, with using this difference, enables the machining on the inside of the hole of cylinder-type, which cannot be seen from an outside thereof, at high accuracy.

In this manner, it is possible to obtain the three-dimensional position of an attended portion of the part, upon which attention is paid, almost in a real-time manner. For this reason, this method can be applied into the machining process with using the lathe or a fraise (milling cutter), in particular, as a monitor for the position of the bite tip, in case where the bite tip cannot be seen from an outside since it is under the cutting the inside of the part.

### Embodiment 3

Explanation will be made on an embodiment 3 of the present invention. The embodiment 3 relates to an assembly built up with “N” pieces of parts, as the target to be inspected, and wherein the sizes and a mutual position relationship of each part are uses as the design data. From this design data are obtained the calculated projection views in two (2) directions, in advance. By comparing the actual projection views in two directions, which are obtained in the similar manner, with the calculated projection views, respectively, as was mentioned above, it is possible to obtain the differences between the actual position and the direction thereof and the design data, for each of “N” pieces of the parts, respectively.

By correcting the design data with this difference, and also producing a calculation mesh for use of a fluid-, heat- or structure-calculation with using this data, it is possible to conduct calculation simulation for reproducing an actual position relationship of each part, with fidelity. The similar thing can be achieved with using the X-ray CT apparatus, but with this, there can be obtained the following advantages. Thus, there is no generation of the specific “artifact”, which can be seen on the X-ray CT apparatus, the calculation mesh can be produced in time much shorter than the X-ray CT apparatus, and further, the X-ray photographing apparatus can be achieved at the cost cheaper than the X-ray CT apparatus.

However, in the present embodiment is applied the X-ray for penetration of the interior configuration of the assembly. But other than the X-ray, it is also possible to apply MRI (Magnetic Resonance Imaging) therein.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An inspecting method of an assembly, for inspecting said assembly, being constructed with a plural number of parts, upon basis of a calculated projection view of showing an interior condition of parts of said assembly, which is obtained through calculation of design data of the assembly, and a projection image for showing the interior condition of parts of said assembly, which is obtained by a photographing apparatus after assembling said assembly, comprising the following steps of:
a step for calculating brightness in vicinity of boundaries, which are obtained when photographing the part to be extracted in plural numbers of directions, from said design data, for each direction;
a step for determining sensitivity of said photographing apparatus upon basis of said brightness, so that the projection image becomes clear in the vicinity of said boundaries;
a step for obtaining the projection images in the plural number of directions for said assembly, by said photographing apparatus;
a step for conducting video processing with converting said projection image into an electric signal, as an actual projection view; and
a step for determining success or failure of said assembly, depending upon said part presented on said actual projection lies or not within a tolerable region of said part, which is presented by said calculated projection view.

2. The inspecting method of an assembly, described in the claim 1, further comprising:
a step for calculating a difference between the position of said part, which is presented by said actual projection view, and the position of said part, which is presented by said calculated projection view.

3. The inspecting method of an assembly, described in the claim 2, wherein
the success or failure of said assembly is determined on whether said difference lies or not within a tolerable value of the difference, which is determined by said design data in advance.

4. An inspecting system of an assembly, for inspecting said assembly, being constructed with a plural number of parts, upon basis of a calculated projection view of showing an interior condition of parts of said assembly, which is obtained through calculation of design data of the assembly, and a projection image for showing the interior condition of parts of said assembly, which is obtained by a photographing apparatus after assembling said assembly, comprising:
a data editor/processor portion, which is configured to store said design data therein, and to produce/edit a calculated projection view;
a brightness calculating portion, which is configured to calculate brightness in vicinity of boundaries, which are obtained when photographing the part to be extracted in plural numbers of directions, from said design data, for each direction;
a sensitivity determining portion, which is configured to determine sensitivity of said photographing apparatus upon basis of said brightness, so that the projection image becomes clear in the vicinity of said boundaries;
the photographing apparatus, which is configured to obtain the projection images in the plural number of directions for said assembly conveyed;
a video processor portion, which is configured to conduct video processing with converting said projection image into an electric signal, as an actual projection view; and
a determination portion, which is configured to determine success or failure of said assembly, depending upon said part presented on said actual projection lies or not within a tolerable region of said part, which is presented by said calculated projection view.

5. The inspecting system of an assembly, described in the claim 4, further comprising:
a difference calculation portion, which is configured to calculate a difference between the position of said part, which is presented by said actual projection view, and the position of said part, which is presented by said calculated projection view.

6. The inspecting system of an assembly, described in the claim 5, wherein
said determining portion determines the success or failure of said assembly on whether said difference lies or not within a tolerable value of the difference, which is determined by said design data in advance.
